(19) United States
(12) Patent Application Publication
(10) Pub. No.: US 2008/0276684 A1
(43) Pub. Date: Nov. 13, 2008

(54) CALIBRATED MEDICAL INSTRUMENT COMPRISING AN ENVIRONMENTAL SENSOR

(76) Inventor: Gunter Goldbach, Worth/Wifling (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 11/758,022

(22) Filed: Jun. 5, 2007

Related U.S. Application Data
(60) Provisional application No. 60/806,506, filed on Jul. 3, 2006.

(30) Foreign Application Priority Data
Jun. 8, 2006 (EP) 06011818

(51) Int. Cl. G01D 18/00

(52) U.S. Cl. 73/1.01

(57) ABSTRACT

A calibrated medical device includes at least one sensor operative to detect at least one environmental influence on the medical device that may change a calibration or operability of the medical device. Based on data collected by the sensor, a determination can be made whether or not the medical device should be re-calibrated.

### RELATED APPLICATION DATA

This application claims priority of U.S. Provisional Application No. 60/806,506 filed on Jul. 3, 2006, which is incorporated herein by reference in its entirety.

### FIELD OF THE INVENTION

The present invention relates generally to medical devices and, more particularly, to a calibrated medical device that includes at least one environmental sensor for detecting or measuring environmental influences on the medical device. The invention also relates to a method for detecting environmental influences that act on a calibrated medical devices and/or that can affect calibration of such medical devices.

### BACKGROUND OF THE INVENTION

When using pre-calibrated medical instruments, devices, or systems (hereinafter collectively referred to as a medical device or medical devices), such as, for example, a pre-calibrated optical tracking system, it is highly important that the technical specification ascertained during calibration (e.g., the shape or geometry of the medical device) has not changed since the calibration procedure. For example, if the orientation of a tracking system camera deviates within a range of just a few thousandths of a degree relative to a calibrated orientation, then the imaging on a CCD (charge coupled device) serving as an image sensor of the camera may be offset by as much as a micrometer. Depending on the distance of a detected marker from the camera, this offset alone can lead to an incorrect detection of the marker in the range of one millimeter. Such an incorrect detection leads to inaccuracies that can have serious consequences.

Since pre-calibrated medical devices are exposed to many different environmental influences, such as, for example, major fluctuations in temperature, mechanical shocks or other stresses, such environmental influences can change (e.g., deform, distort, bend, etc.) the medical devices. This can result in part or all of the medical device being out of calibration.

Transporting a medical device from a manufacturer to a customer or moving a mobile medical device within a building, such as for example a hospital, can introduce jarring or mechanical shock on the medical device. This can change a shape, geometry or orientation of some parts of the medical device and, therefore, the medical device should be re-calibrated.

### SUMMARY OF THE INVENTION

A calibrated medical device comprises at least one and preferably two or more sensors for identifying or detecting environmental or external influences on the medical device that may change or affect a shape, calibration, geometry or general operability of the device. A calibrated medical device as used herein is an instrument, device, system, or the like in which the components relevant to its operability are calibrated before the instrument, device, system is used, or in which relevant properties (e.g., a shape and/or orientation) have been determined.

In a medical device comprising a tracking system, for example, the position and orientation of two or more infrared cameras used for imaging can be determined and stored in a database or in software. Equally, it is also possible to detect the complete geometry of an instrument, such as for example a pointer connected to markers, wherein the markers and their position relative to the pointer tip may be regarded as relevant components that are important for its use. If there is an external influence, such as for example an external force acting on the medical device, then the device may be changed (e.g., deformed, altered, etc.). This change can be detected by means of the at least one sensor, wherein the sensor, for example, can be connected to or integrated into the medical device. This can provide the user with an indicator by which it is possible to ascertain whether external influences above a predetermined limit have acted on the medical device, such that the medical device may be out of calibration and, therefore, should be calibrated prior to use. This can ensure a specified accuracy of the medical device.

In general, any medical device can be provided with or connected to at least one sensor for monitoring whether, and if so, which environmental influences are acting or have acted on the medical device. A sensor, for example, can be attached to any component of a tracking system, including a camera of the tracking system, an instrument calibration matrix (ICM), a fluoro-registration kit, a pointer, an ultrasound phantom, an MR coil array (e.g., head coils), an implant or any other factory-calibrated instruments.

The at least one sensor connected to, provided on, or attached to the medical device can be a temperature sensor, a shock sensor, an acceleration sensor, a strain sensor (e.g., a strain gauge), a humidity sensor, a magnetic field sensor (e.g., a Hall sensor), a pressure sensor, a radiation sensor for detecting ultraviolet, infrared or x-ray radiation or any other sensor relevant to the calibration of the medical device. It is also possible to provide more than one sensor on the medical device, for example at different locations, wherein multiple identical or different sensors can be attached to the medical device in order to simultaneously detect different environmental influences, such as shocks and fluctuations in temperature, for example.

The sensor can be connected to a storage or recording mechanism in which the type or magnitude of the external factor acting on the medical device may be detected. Optionally, a timer or clock also can be provided, such that the sensor signals can be stored in the memory together with the detection time of the sensor signals. This enables the detection of a major influence on the medical device, such as a severe shock, for example, to be correlated with a specific time. Furthermore, it is also possible to provide a position detection system, such as a known GPS system, on the medical device or sensor. The position detection system can be used to ascertain a location of the medical device when said stresses or influences occurred. Further, the positional signals or GPS signals can be stored in the memory together with the sensor signals or time signals.

The one or more sensors may be powered by any suitable energy source, such as for example a battery (including a rechargeable battery), a fuel cell, a solar cell or even a capacitor (preferably a high-capacitance capacitor such as a gold capacitor). The power supply also may provide power to evaluation or storage circuitry. Depending on the type of factor to be detected or measured, sensors or detection mechanisms also can be used that do not need an additional power supply. The energy acting on the instrument due to x-ray radiation, for example, can be integrated on special semiconductor elements, or the energy for recording or detecting the external influence can be obtained from this influence itself. Further, the energy provided from a mechanical shock can be converted into electrical energy, or serve as an energy source for a detection or recording mechanism such as is known, for example, from automatic watches. Equally, piezo-based acceleration sensors also can be used that store mechanical shocks or influences or relay them as electrical signals, wherein the mechanical shocks are converted into electrical energy.

A status display or a way of polling the status can be provided on the medical device, wherein the charge level of the power supply, for example, can be displayed. Equally, it is possible to optically and/or acoustically output the influence data detected by the sensor or sensors. For example, if the influence data is stored in the memory, then a memory reading procedure may be initiated by operating a push button. An infrared LED can be provided, via which a camera of a tracking system may be signaled, thereby indicating that the medical device lying in the detection range of the tracking system should be re-calibrated. Further, it is also possible to provide an electric interface (e.g., a USB port or the like), via which the sensor or memory of the medical device can be controlled and read so as to ascertain whether the medical device should be calibrated.

A removable data medium such as, for example, a USB memory stick, CF memory card, SD memory card or the like can be provided. This provides easy access of the data to a technician who may simply remove and/or exchange the memory card and place it in a reader (e.g., a PC or the like). The recorded data then can be removed as a “logbook” of the medical device and, for example, read and evaluated by means of a suitable service computer. The medical device also can include an interface for remote maintenance, such that for example a memory provided in the medical device can be read, or the sensors provided on the medical device can be polled via radio, infrared or other data transmission mechanisms.

In accordance with another aspect of the invention, there is provided a method for detecting environmental influences or physical or chemical influences on a calibrated medical device so as to ascertain whether the medical device or parts of it have been affected or changed and should be calibrated or re-calibrated.

The environmental influences may be continuously detected in order to ensure that undesirable and unidentified influences on the medical device have not occurred. The signals detected by the at least one sensor can be recorded, wherein a time stamp and/or positional data, for example, can be stored together with the signals in a memory.

A limit for the monitored parameter can be determined for at least one or for each sensor, and a warning signal can be output when the respective limit is exceeded and/or stored in the memory. Thus, for example, a maximum magnitude of a force acting on the medical device can be predetermined for a mechanical or shock sensor, wherein when this force is exceeded, it may be assumed that the calibration of the medical device has been lost and that the device should be re-calibrated. To this end, a warning signal can be output, either immediately when the external influence occurs or time-delayed, for example, once the calibration status has been has been polled. When using temperature sensors, a minimum and maximum temperature can be predetermined, wherein when the detected temperature exceeds or falls below these temperatures, corresponding warning signals can likewise be output or stored.

Further, the method described herein may be embodied as a computer program, and can be stored on a computer readable medium.

### BRIEF DESCRIPTION OF THE DRAWINGS

The forgoing and other features of the invention are hereinafter discussed with reference to the drawings.

FIG. 1 is a schematic diagram illustrating an exemplary navigation system that includes exemplary sensors in accordance with the invention.

FIG. 2 is a flow diagram that illustrates an exemplary method for monitoring environmental influences on a medical device in accordance with the invention.

### DETAILED DESCRIPTION

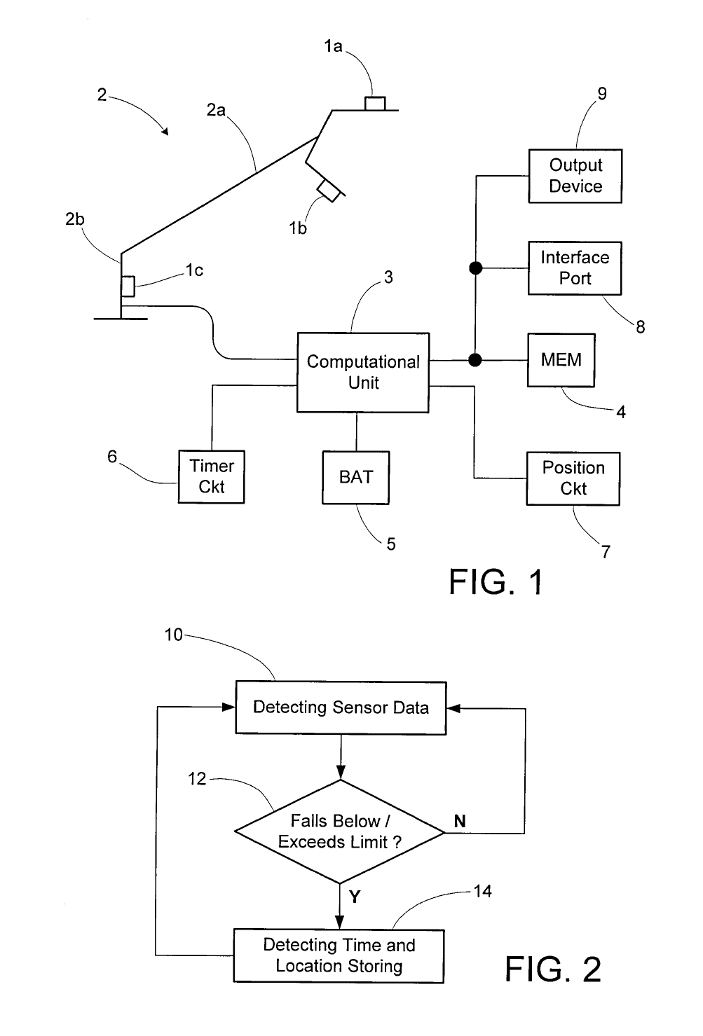

FIG. 1 shows a navigation or tracking system 2 that comprises a pre-calibrated infrared camera 2a, wherein shock sensors 1a and 1b are provided on the camera 2a. Furthermore, an array including multiple sensors 1c (e.g., mechanical shock sensors or temperature sensors), which monitor environmental influences on the system 2, are provide in a support 2b of the camera 2a. Although not shown, other sensors also may be employed, including humidity sensors, position sensors, etc.

The sensors 1a to 1c may be operatively connected to a computer 3, memory 4 and battery 5, timing circuit 6, position circuit 7, interface port 8 and output device 9. Although each of the above are shown as separate components, parts or all thereof may be implemented in a single device (e.g., on a single semiconductor chip or the like).

The battery 5 provides power to the sensors 1a to 1c and the units connected to them. If, for example, a shock occurs while the navigation system 2 is being transported (e.g., the navigation system slides against a loading door), then a logbook entry can be stored in the memory 4, wherein the logbook entry may include, for example, a magnitude of the shock, a time at which the shock occurred (e.g., determined by the timing circuit 6), and a corresponding signal indicating where the navigation system 2 is located (e.g., determined by the position circuit 7) at the time the shock occurred. When the navigation system 2 is put into operation, the computer 3, which may be a micro controller, for example, can read the memory 4 and output a warning via a status output via output device 9 (e.g., a display, audible output, wireless signal, etc.) that a severe mechanical shock has been detected that may have changed the calibration of the system, such that said system should be re-calibrated. Alternatively, the data may be provided to external equipment via the interface port 8 (e.g., a universal serial bus or the like).

By means of the sensor array 1c, it is equally possible to record the environmental pressure, for example during transport by an aircraft, fluctuations in humidity or radiation loads on the system 2, which can cause pixel artifacts that may lead to damage to the system 2 or a reduction in accuracy. Equally, it is possible to detect whether fluid has entered the system 2, for example during a cleaning procedure, or whether the system 2 has been exposed to extreme magnetic fields, which, for example, may be the case in an MRT environment.

FIG. 2 illustrates an exemplary method for continuously detecting data from the sensors 1a to 1c. Beginning at block 10, the sensor data may be detected (e.g., read from the sensor), and at block 12 a check can be made as to whether the sensor data exceed or fall below a predetermined limit. If it is detected that the sensor data do not exceed or fall below the limit, then the method moves back to block 10 and the sensor data continue to be detected or read. If the sensor data do exceed or fall below the limit, then, in addition to the particular sensor signal, the time at which the data is detected and the location (e.g., GPS signal) of the medical device when the data is detected (e.g., as detected by the timing circuit 6 and position circuit 7, respectively) and stored in the memory MEM 4 together with the sensor signal, as indicated at block 14. This stored data may be retrieved at a later time, e.g., when the system 2 is put into operation.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A calibrated medical device, comprising at least one sensor operative to detect at least one environmental influence on the medical device that may change a calibration or operability of the medical device.

2. The medical device according to claim 1, wherein the medical device is at least one of a tracking system, a camera of the tracking system, an instrument calibration matrix, a fluoro-registration kit, a pointer, an ultrasound phantom, an MR coil array, or an implant.

3. The medical device according to claim 1, wherein the at least one sensor is at least one of a temperature sensor, a shock sensor, an acceleration sensor, a strain sensor, a humidity sensor, a magnetic field sensor, a pressure sensor or a radiation sensor.

4. The medical device according to claim 1, further comprising a memory operatively coupled to the at least one sensor.

5. The medical device according to claim 4, wherein the memory is a removable data medium, wherein sensor signals are storable on the removable data medium.

6. The medical device according to claim 1, further comprising a power supply operatively coupled to the at least one sensor.

7. The medical device according to claim 1, wherein the power supply is a battery,

8. The medical device according to claim 1, further comprising a timer circuit and/or a location determination circuit.

9. The medical device according to claim 8, wherein the location determination circuit is at least part of a GPS system.

10. The medical device according to claim 1, further comprising an output device operative to provide an output signal indicative of the medical device being out of calibration.

11. The medical device according to claim 1, further comprising an interface port operatively coupled to at least one of the at least one sensor, a memory, a timer circuit or a location detection circuit, said interface port operative to provide data from the medical device to other equipment.

12. A method for determining if a calibrated medical device requires re-calibration, comprising:
detecting at least one external factor affecting the medical device; and
checking if the at least one external factor is sufficient to change the calibration of the medical device.

13. The method according to claim 12, wherein detecting the at least one external factor includes detecting an external physical factor or an external chemical factor affecting the medical device.

14. The method according to claim 12, wherein detecting includes continuously detecting the external factor.

15. The method according to claim 14, wherein continuously detecting includes continuously recording the at least one external factor.

16. The method according to claim 12, wherein detecting includes recording the at least one external factor when the external factor satisfies a predetermined criteria.

17. The method according to claim 12, further comprising determining a time when the external factor is detected and/or location of the medical device when the external factor is detected.

18. The method according to claim 12, further comprising providing a signal when the medical device is to be re-calibrated.

19. The method according to claim 12, further comprising storing the at least one detected external factor in a removable data medium.

20. The method according to claim 12, further comprising providing the at least one detected external factor to other equipment for remote maintenance.

21. A computer program embodied on a computer readable medium for determining if a calibrated medical device requires re-calibration, comprising:
code that detects at least one external factor affecting the medical device; and
code that checks if the at least one external factor is sufficient to change the calibration of the medical device.
